(19) United States
(12) Patent Application Publication
(10) Pub. No.: US 2011/0061382 A1
(43) Pub. Date: Mar. 17, 2011

(54) System and Method for Extracting Geothermal Energy From a Potentially Seismically Active Stratum, With Reduced Accompanying Seismic Disturbances

(76) Inventor: Richard H. Stern, Washington, DC (US)

(21) Appl. No.: 12/884,006

(22) Filed: Sep. 16, 2010

Related U.S. Application Data
(60) Provisional application No. 61/276,864, filed on Sep. 17, 2009.

(51) Int. Cl. F03G 7/00; F28D 15/00

(52) U.S. Cl. 60/641.2; 165/104.21

(57) ABSTRACT

A closed loop system and method for extracting geothermal are disclosed. They do not fracture subterranean rock structures or let fluid into the structures or extract fluid from them, thereby lessening the risk of causing seismic disturbances and pollution of groundwater.

### CLAIM OF PRIORITY

This application makes reference to, incorporates the same herein, and claims all benefits accruing under 35 U.S.C. §119 from an provisional patent application filed in the U.S. Patent and Trademark Office on the 17 Sep. 2009, and there duly assigned Ser. No. 61/276,864.

### BACKGROUND OF THE INVENTION

### Field of the Invention

The present invention relates generally to extraction of geothermal energy from deep, potentially seismically active subterranean strata, with reduced accompanying seismic disturbances. In particular the invention concerns a closed-loop energy extraction system that avoids fracturing subterranean formations and avoids establishing an injection and extraction cycle that periodically alters subterranean configurations, each of which may trigger earthquakes.

Presently used and/or contemplated technology in this field pumps cool water down 2 to 3 miles into the earth through a primary well, where it fractures, and creates fissures in, the hot dry rock 2-3 miles down. The water flows into the fissures, creating very hot water in the fissures. The heated water is then pumped back up to the surface via one or more secondary wells. As it rises, the pressure of the very hot water decreases and it becomes steam. The steam is then fed to a power plant to generate electricity. See FIG. 1 (Related Art).

### SUMMARY OF INVENTION

The present invention provides a system and process for extracting, with reduced accompanying seismic disturbances, geothermal energy from deep, potentially seismically active, subterranean strata. The invention accomplishes this by using a closed-loop process that, unlike the prior art, does not inject water into the subterranean rock or extract water from it, thus eliminating the expansion and contraction occurring in the currently used sponge process. The invention also refrains from fracturing the subterranean formations, again unlike the prior art. The invention uses proven oil-drilling technology to bring about its results. This technology is helpfully summarized in published patent application, US 20070193743.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 represents the related art.

FIG. 2 is a schematic drawing of a cased well of this invention. This is the “U” implementation.

FIG. 3 is a schematic drawing of a well of this invention. This is the “L” or “J” implementation.

None of these drawings are to scale.

### DETAILED DESCRIPTION OF THE INVENTION

According to a 2007 MIT geothermal report financed by the U.S. Energy Department (DOE), advanced geothermal power could in theory produce as much as 60,000 times the nation's annual energy usage. An significant obstacle, however, to greater exploitation of geothermal energy is the risk of triggering earthquakes.

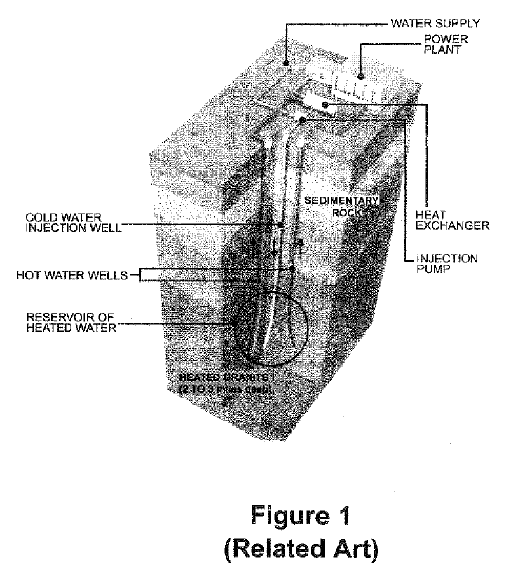

As recounted in a Jun. 23, 2009, New York Times story, “The Danger of Digging Deeper,” presently used geothermal energy technology operates by injecting water into hot rock deep in the earth, filling up subterranean aquifers with hot water, and then extracting the hot water or resulting steam to use its heat. See FIG. 1 (Related Art). This process is repeated in a cycle that resembles periodically soaking a sponge and then squeezing the water from it, thereby expanding and contracting the sponge-like subterranean structure. That in turn, it is said, sets off seismic disturbances—earthquakes. It is also accused of contaminating aquifers and ground water.

A new project, poised to bore 2.5 miles, far into the hot rock and deeper than prior U.S. wells, renewed concerns about triggering earthquakes. The project site is 40 miles from the San Andreas Fault and even closer to other faults. A similar project in Basel, Switzerland, was shut down in 2006 because it triggered earthquakes. See Jun. 23, 2009, New York Times story, “Deep in Bedrock, Clean Energy and Quake Fears.” An Australian project proposes to bore down 4.5 km (2.5 ml) to a granite stratum to provide 270° C. heat for a power plant.

In July 2009, after the publication of the foregoing New York Times story, the Energy Department and the Bureau of Land Management informed the company working on the foregoing geothermal project near the San Andreas fault that it would not be allowed to fracture rock until the department completed a new review of whether the project would be safe. On Sep. 2, 2009, the company announced that its difficulties prevented continuation of the project: “As a result, we have suspended the drilling of this well as part of the Geysers Demonstration project.

The sponge-like water injection and extraction process (“sponge process”) of current technology can be observed in a DOE flash animation, which is available at <http://www1.eere.energy.gov/geothermal/printable_versions/egs_animation.html>. This animation shows the injection and withdrawal of water from a subterranean region in carrying out the sponge process, which is considered to stress the subterranean structures. It would be desirable to provide a geothermal energy extraction process that operated efficiently for this purpose without causing a risk of earthquakes or aquifer contamination, for which fracturing and the injection-withdrawal process are widely blamed and which blame thus stands as an obstacle to the development of geothermal energy extraction. An alternative to the presently used sponge process would therefore be desirable.

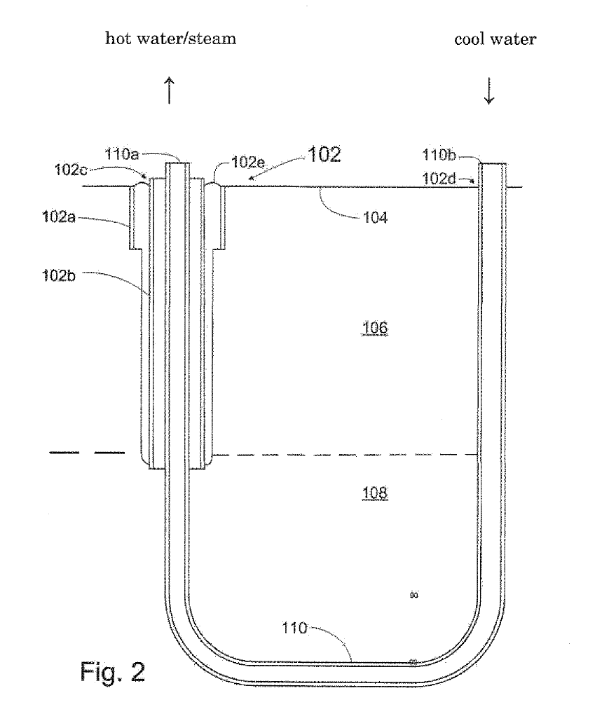

Referring to FIG. 2, showing a “U” implementation of system 102 of the invention, a cased well 110b is first driven from the earth's surface 104 through intervening overburden rock 106 down into a deep subterranean stratum 108 rich in geothermal energy. (In this context the term “deep” refers to a depth of at least one mile below the earth's surface. Two or more miles is commonly the depth of the desired geothermally rich region.) A cased version is shown, with casing 102d surrounding the path for the heat-transfer fluid. (The first step of the “L” implementation is similar to that just described.)

This first step provides a first section of a continuous, closed subterranean path. This first section is generally vertical (but not necessarily strictly vertical, because slant drilling technology may be used).

Deviated or directional drilling is then used to provide a gradual change in direction from the generally vertical first section to a generally horizontal second section 110, which extends through a part of the stratum 108 rich in geothermal energy. It is necessary to drill either very long or a great number of essentially horizontal wellbores 110 (the second section) in the geothermally rich rock to get sufficient heat transfer from the hot rock to the heat-transfer fluid. The number and/or configuration of the wellbores is a function of the heat transfer required, based on the temperature and characteristics of the geothermal formation in question and the size of the geothermal requirements for power generation. (This step is also similar for both “U” and “L” implementations.)

At this point the respective configurations of the two different implementations begin to differ substantially.

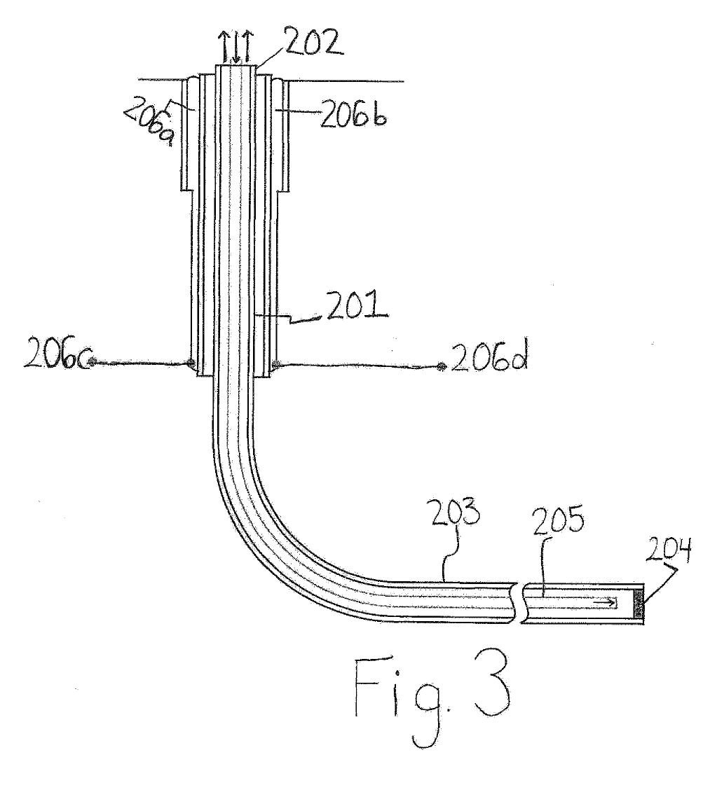

In the “L” (or “J”) implementation of FIG. 3, the two well sections described above provide the whole continuous subterranean bored path. The first section 201 is a cased well (as shown in FIG. 2) or uncased well. The well can be uncased only where the rock makeup of the geothermal formation is very stable (i.e., the borehole won't collapse without casing), isn't porous and permeable (i.e., water won't invade the formation) and doesn't contain undesirable water soluble/leachable minerals that would cause scaling and other operational problems. There are large cost savings where casing is not required, but it cannot be avoided where the rock makeup lacks the properties described above.

Assuming a formation lacking the foregoing desirable properties, the first section 201 of the “L” implementation of FIG. 3 is a cased well containing a continuous pipe that enters the upper end or entry port 202 of the first section, descends to the lower end of the first section, which connects to and communicates along a curved path with the proximal end of a long second section 203. This second section can be up to five or more miles long. (Maersk Oil Qatar reported that in 2008 it drilled a well to a length of 40,320 feet (12.3 km), with a horizontal section of 35,770 feet (10.9 km). Maersk describes this advanced, deep oil well drilling operation in <http://www.maerskoil.com/en/Technology/Pages/Innovation.aspx>. A further description of the technical details of the relevant technology for this well is found in the July-August 2009 issue of Drilling Contractor, pp. 34-40, available at <http://www.slb.com/˜/media/Files/drilling/industry_articles/200907_dc_longest_well_qatar.ashx>.)

First section 201 makes an “L” with a bottom or foot 203 much longer than its vertical stem 201. The path for the heat-transfer fluid then extends through second section 203 to a distal end 204 thereof, where the continuous path for the heat-transfer fluid turns around, enters a pipe 205 and then extends back to the proximal end of the second section, absorbing heat from the hot rock as it goes, passes back into the first section, and ascends to the earth's surface, where the entry and exit ports 202 of the pipe are located. The continuous subterranean path of this implementation is essentially “L” (or “J”) shaped; hence the designation. Depending on relative costs, it may be economically advantageous to surround the pipe of a cased well with high temperature insulating cement 206a-d to prevent loss of heat from the pipe to the rock. That is a cost trade-off matter, since the cement adds to the cost.

In the “L” implementation the casing pipe or borehole contains a smaller diameter pipe 205 (a “cool-fluid carrier pipe”) within it extending almost to the distal end 204 of the horizontal section. Water or another heat transfer fluid is piped through the cool-fluid carrier pipe, down to the distal end, where the cool fluid exits the smaller diameter pipe 205 and enters the larger surrounding pipe or borehole 203 at the distal end thereof. The heat-transfer fluid that was within the smaller diameter cool-fluid carrier pipe 205 then passes through the annulus of the larger diameter pipe or borehole 203 which surrounds the smaller diameter pipe 205, absorbing heat from the hot rock around it, ordinarily vaporizing (this depends on pressure), and finally returning to the surface. (The exit port of the continuous subterranean path of the “L” implementation surrounds the entry port, at the earth's surface.)

It is considered possible to implement this aspect of the invention with the cool fluid on the outside of the pipe and the heated fluid within the smaller-diameter pipe, and it is considered that this system is an equivalent of that described above, but this approach is considered less advantageous because of heat-transfer considerations.

A further advantage of the “L” implementation is that it permits tapping geothermal energy from strata located under obstacles, such as mountains or bodies of water, where an additional well bore cannot feasibly be located. It also permits extraction of geothermal energy from under a national park or other area where locating surface facilities would be impermissible, dangerous, or otherwise infeasible.

Referring to FIG. 2, in the “U” implementation (the bottom of the “U” is very long relative to the sides, somewhat like long side of a rectangle with the other long side omitted), the continuous subterranean path for the heat-transfer fluid as does not end at the distal end of the horizontal section: a third, generally vertical section is added to the continuous subterranean path. The path for the heat-transfer fluid does not reverse its direction in this implementation. It instead proceeds from the distal end of the second section of the continuous subterranean path through the lower end of the third section and then ascends through the third section to the upper end thereof at the earth's surface, where the exit port of the path is located.

The lower end of the third section connects to and communicates with the distal end of the second section 110. The upper end 110a of the third section is at the earth's surface 104. (The continuous subterranean path of this implementation is “U” shaped, as described above—with a very long bottom part).

In both implementations the borehole path or its pipe is filled with a heat-transfer fluid; the exit port of the borehole path or pipe is adapted to be connected to a conventional heat exchanger so that heat can be extracted from the system, for operating a turbine or other use; and a pumping station is located so as to be able to supply heat-transfer fluid to the entry port of the path or pipe. The heat-transfer fluid can be steam or a synthetic heat transfer medium, such as Dowtherm® or Paratherm®. A hot rock system providing 270° C. heat may advantageously utilize a heat-transfer fluid with a boiling point somewhat below is that temperature, so that the fluid vaporizes when passing through the second section and thus acquires additional energy in the form of latent heat of vaporization; this additional energy can then be yielded to the heat exchanger when the fluid condenses.

Ordinarily, the exit from the heat exchanger connects to the pumping station to provide a single continuous closed path for the heat-transfer fluid, but this is not necessary. The continuous subterranean path is what must be a closed loop to prevent interaction with the deep rock stratum that could trigger seismic activity (and cause pollution); the surface operation does not pose that risk, so it need not be closed-loop. If the heat-transfer fluid is water/steam, it may be vented to the atmosphere after heat exchange instead of condensing it, if the path (a pipe) from the heat exchanger to the pumping station is not closed-loop. Whether venting or condensation is used is an economic trade-off, depending on costs and availability of water.

In FIGS. 2 and 3, the use of insulation is shown. In this optional feature, conventional technology is used to conserve energy in the heated heat-transfer fluid pipe of the “L” implementation (or third section in the “U” implementation). This section of the path has a casing around it so that it can be cemented to a depth of approximately 1000 feet from the surface with high temperature insulating cement 102e to reduce heat loss from the hot fluid into the overburden. The cement thus provides thermal insulation, thereby conserving energy usage and reducing thermal pollution of the overburden that might be detrimental to ground water located in the overburden. The cement may advantageously be prepared as class “G” cement with 35% silica flour, 3% CaCl₂, and 10% spherellite. It is appropriate, also, to prepare thermal insulating cement with bubble alumina or exfoliated vermiculite as aggregate, or to use foamed cement (with or without aggregate) to minimize cost. Other cements may also be used if they are capable of substantially lessening heat transmission from the overburden casing to the surrounding overburden.

While the invention has been described in connection with specific and preferred embodiments thereof, it is capable of further modifications without departing from the spirit and scope of the invention. This application is intended to cover all variations, uses, or adaptations of the invention, following, in general, the principles of the invention and including such departures from the present disclosure as come within known or customary practice within the drilling art or as are obvious to persons skilled in that art, at the time the departure is made. It should be appreciated that the scope of this invention is not limited to the detailed description of the invention hereinabove, which is intended merely to be illustrative, but rather comprehends the subject matter defined by the following claims.

The subject matter claimed is:

1. A system, said system comprising:
a continuous subterranean path for extracting, with reduced accompanying seismic disturbances, geothermal energy from potentially seismically active subterranean strata, said continuous subterranean path comprising at least a first section and a second section;
said first section extending generally downward from an upper end of an earth-surface location to a lower end of said first section, said lower end at a depth of at least one mile to a naturally occurring subterranean stratum rich in geothermal energy;
said second section having a proximal end connected to and communicating with said lower end of said first section, said second section extending through the subterranean stratum rich in geothermal energy from said proximal end of said second section to a distal end of said second section;
said continuous subterranean path having an entry port adapted to introduce heating transfer fluid under pressure into said continuous subterranean path at said upper end of said first section, descending from the entry port to said lower end of said first section, extending from said lower end of said first section through said proximal end of said second section to said distal end of said second section, and extending from said distal end to an exit port of said subterranean path at an earth-surface location; and
said continuous subterranean path transporting the heat-transfer fluid from said entry port to said exit port without any substantial leakage of the heat-transfer fluid, to a heat exchanger having an entry port connectable to said exit port of said path to receive said heat-transfer fluid.

2. The system of claim 1 wherein said continuous path of said heat-transfer fluid also extends back from said distal end of said second section to said proximal end of said second section and said lower end of said first section, and then extends back therefrom through said first section to said exit port of said continuous path and to said upper end of said first section, said entry port and said exit port respectively entering and exiting said first section of said path concentric with one another or in close proximity.

3. The system of claim 1 wherein said first section contains a cool-fluid carrier pipe within it, said cool-fluid carrier pipe having a diameter smaller than that of said first section, said cool-fluid carrier pipe extending from said earth-surface location to said distal end of said first section, passing through said distal end of said first section and through said proximal end of said second section, and extending to a distal end of said cool-fluid carrier pipe located near the distal end of said second section; said cool-fluid carrier pipe open at said distal end thereof and communicating there with the interior of said second section near said distal end thereof.

4. The system of claim 1 wherein at least a part of said pipe located within said first section is surrounded by high temperature insulating cement.

5. The system of claim 1 having a third section of said continuous subterranean path and wherein said distal end of said second section of said continuous subterranean path connects to and communicates with a lower end of said third section of said continuous subterranean path, said third section then extends upward from said lower end thereof to an upper end thereof at an earth-surface location, and said path extends from said distal end of said second section through said third section to said upper end thereof and through said exit port of said path.

6. The system of claim 5 wherein at least a part of said pipe located within said third section is surrounded by high temperature insulating cement.

7. The system of claim 1 wherein said heat-transfer fluid is steam.

8. The system of claim 1 wherein said heat-transfer fluid is a synthetic heat transfer medium.

9. The system of claim 1 wherein said pumping station has an entry port connected to and communicating with said exit port of said heat exchanger, to provide a closed loop system in which said heat-transfer fluid passes from said pumping station to said entry port of said path, through said subterranean path to said heat exchanger, and from said heat exchanger to said pumping station in a continuous closed loop cycle.

10. A method for extracting, with reduced risk of accompanying seismic disturbances, geothermal energy from potentially seismically active subterranean strata, said method comprising:
(1) Circulating a heat-transfer fluid through a closed continuous subterranean path comprising at least a first section and a second section;
said first section extending generally downward at least one mile from an upper end thereof at an earth-surface location to a lower end of said first section, said lower end at a depth at which is located a subterranean stratum rich in geothermal energy;
said second section having a proximal end connected to and communicating with said lower end of said first section, said second section extending through said subterranean stratum rich in geothermal energy from said proximal end of said second section to a distal end of said second section;
said continuous subterranean path having an entry port at said upper end of said first section, descending therefrom to said lower end of said first section, extending therefrom through said proximal end of said second section to said distal end of said second section, and extending from said distal end to an exit port of said path at an earth-surface location;
said continuous path adapted to contain said heat-transfer fluid and to transport said heat-transfer fluid from said entry port to said exit port without any substantial leakage of said heat-transfer fluid into said subterranean stratum; and
(2) Passing said heat-transfer fluid from said subterranean path to a heat exchanger having an entry port and an exit port, said entry port of said heat exchanger connected to and communicating with said exit port of said path and adapted to receive said heat-transfer fluid therefrom.

11. The method of claim 10 wherein said heat-transfer fluid is steam.

12. The method of claim 10 wherein said heat-transfer fluid is a synthetic heat transfer medium.

13. The method of claim 10 wherein said first section contains a cool-fluid carrier pipe within it, said cool-fluid carrier pipe having a diameter smaller than that of said first section, said cool-fluid carrier pipe extending from said earth-surface location to said distal end of said first section, passing through said distal end of said first section and through said proximal end of said second section, and extending to a distal end of said cool-fluid carrier pipe located near the distal end of said second section; said cool-fluid carrier pipe open at said distal end thereof and communicating there with the interior of said second section near said distal end thereof, whereby said heat-transfer fluid passes through said pipe to the distal end to thereof, passes into the second section of said path surrounding said pipe, absorbs heat from the subterranean stratum rich in geothermal energy, and proceeds through said pipe to said earth-surface location and an exit port of said pipe.

14. The method of claim 10 wherein said distal end of said second section connects to and communicates with a lower end of a third section, said third section extends upward from said lower end thereof to an upper end thereof at an earth-surface location, and said continuous path extends from said distal end of said second section through said third section to said upper end thereof and to said exit port of said path.

15. The method of claim 10 wherein said heat-transfer fluid has a boiling point at a temperature below that of said stratum through which said second section extends, so that said heat-transfer fluid acquires additional energy from latent heat of vaporization of said heat-transfer fluid, when passing through said second section, said additional energy then being yielded to the heat exchanger when said heat-transfer fluid passes therethrough.

16. A method of reducing risk of causing seismic disturbances when extracting geothermal energy from a potentially seismically active location, said method comprising carrying out the method of claim 10, thereby extracting geothermal energy with a reduced risk of causing seismic disturbances in doing so.

17. A method of reducing risk of causing seismic disturbances when extracting geothermal energy from a subterranean stratum rich in geothermal energy at a potentially seismically active location, said method comprising:
(1) establishing a closed-loop well extending from the earth's surface at least one mile down into and horizontally though a naturally occurring subterranean stratum rich in geothermal energy at a potentially seismically active location, said well containing a heat exchange fluid in the closed-loop well and isolating the heat exchange fluid within said well from the stratum while refraining from fracturing rock at the potentially seismically active location; and
(2) heating said heat exchange fluid by pumping said heat exchange fluid through said closed-loop well, within the stratum and then returning said heat exchange fluid to the earth's surface.

18. The system of claim 1 wherein said heat-transfer fluid has a boiling point at a temperature below that of said stratum through which said second section extends, so that said heat-transfer fluid acquires additional energy from latent heat of vaporization of said heat-transfer fluid, when passing through said second section, said additional energy then being yielded to the heat exchanger when said heat-transfer fluid passes therethrough.
